(19) United States
(12) Patent Application Publication
(10) Pub. No.: US 2021/0168097 A1
(43) Pub. Date: Jun. 3, 2021

(54) INFORMATION PROCESSING APPARATUS, INFORMATION PROCESSING SYSTEM, AND METHOD OF PROCESSING INFORMATION

(71) Applicant: KAZUAKI NAKAMURA, KANAGAWA (JP)

(72) Inventor: KAZUAKI NAKAMURA, KANAGAWA (JP)

(73) Assignee: Ricoh Company, Ltd., Tokyo (JP)

(21) Appl. No.: 17/097,343

(22) Filed: Nov. 13, 2020

(30) Foreign Application Priority Data
Nov. 28, 2019 (JP) 2019-215735

(51) Int. Cl. H04L 12/58; H04L 29/12; G06F 16/953; G09B 7/00

(52) U.S. Cl. CPC H04L 51/02; G09B 7/00; G06F 16/953; H04L 61/2007

(57) ABSTRACT

An information processing apparatus connectable with a user terminal via a network includes circuitry configured to acquire a question statement input to the user terminal by a user; search response information to be responded to the question statement; respond, to the user terminal, a response message based on the searched response information to the question statement; and control output of the response message to the question statement input to the user terminal such that a first response message responding to a first question input source used for inputting a first question statement, and a second response message responding to a second question input source used for inputting a second question statement are different even if the first question statement and the second question statement are similar or the same.

### CROSS-REFERENCE TO RELATED APPLICATION

This application claims priority pursuant to 35 U.S.C. § 119(a) to Japanese Patent Application No. 2019-215735, filed on Nov. 28, 2019 in the Japan Patent Office, the disclosure of which is incorporated by reference herein in its entirety.

### BACKGROUND

### Technical Field

This disclosure relates to an information processing apparatus, an information processing system, and a method of processing information.

### Background Art

Conventionally, apparatuses such as computers recognize patterns of text, audio voice, or image input by users via a network. Then, based on results of pattern recognition, the apparatuses such as computers respond to instructions or questions spoken by users, or perform the device control in response to receiving instructions spoken by users, and such computers is known as “chat bot” or simply referred to as “bot.”

For example, a conventional method of displaying information using characters and pictures indicating which branch is to be selected can be used to assist editing of dialogue scenarios used for the chat bot. By using this method of displaying the information of options collectively, the editing of dialogue scenarios, which may be changed depending on the flow, can be assisted.

### SUMMARY

As one aspect of the present disclosure, an information processing apparatus connectable with a user terminal via a network is devised. The information processing apparatus includes circuitry configured to acquire a question statement input to the user terminal by a user; search response information to be responded to the question statement; respond, to the user terminal, a response message based on the searched response information to the question statement; and control output of the response message to the question statement input to the user terminal such that a first response message responding to a first question input source used for inputting a first question statement, and a second response message responding to a second question input source used for inputting a second question statement are different even if the first question statement and the second question statement are similar or the same.

As another aspect of the present disclosure, an information processing system is devised. The information processing system includes a user terminal used for receiving an input from a user; and an information processing apparatus connectable with the user terminal via a network. The information processing apparatus includes circuitry configured to acquire a question statement input to the user terminal by a user; search response information to be responded to the question statement; respond, to the user terminal, a response message based on the searched response information to the question statement; and control output of the response message to the question statement input to the user terminal such that a first response message responding to a first question input source used for inputting a first question statement, and a second response message responding to a second question input source used for inputting a second question statement are different even if the first question statement and the second question statement are similar or the same.

As another aspect of the present disclosure, a method of processing information using an information processing apparatus connectable with a user terminal via a network is devised. The method includes acquiring a question statement input to the user terminal by a user; searching response information to be responded to the question statement; responding, to the user terminal, a response message based on the searched response information to the question statement; and in the responding, controlling output of the response message to the question statement input to the user terminal such that a first response message responding to a first question input source used for inputting a first question statement, and a second response message responding to a second question input source used for inputting a second question statement are different even if the first question statement and the second question statement are similar or the same.

### BRIEF DESCRIPTION OF THE DRAWINGS

A more complete appreciation of the description and many of the attendant advantages and features thereof can be readily acquired and understood from the following detailed description with reference to the accompanying drawings, wherein:

FIG. 1 is an example of configuration of an information processing system according to an embodiment of this disclosure;

FIG. 2 is an example of configuration of hardware block diagram of user terminal;

FIG. 3 is an example of configuration of hardware block diagram of administrator terminal;

FIG. 4 is an example of configuration of hardware block diagram of server;

FIG. 5 is an example of flow of dialogue based on scenario information;

FIG. 6 is an example of category information;

FIG. 7 is an example of question-answer information;

FIG. 8 is an example of inquiry history information;

FIGS. 9A and 9B are an example of dialogue history information;

FIG. 10 is an example of configuration of functional block diagram of chat bot system;

FIG. 11 is an example of sequence diagram of processing for implementing chat bot service;

FIG. 12 is an example of flowchart illustrating a processing of determining condition; and

FIG. 13 is an example of registration of setting information.

The accompanying drawings are intended to depict embodiments of the this disclosure and should not be interpreted to limit the scope thereof. The accompanying drawings are not to be considered as drawn to scale unless explicitly noted.

### DETAILED DESCRIPTION

A description is now given of exemplary embodiments of the present inventions. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, region, layer or unit discussed below could be termed a second element, component, region, layer or unit without departing from the teachings of the present inventions.

Further, it should be noted that the terminology used herein is for the purpose of describing particular embodiments only and is not intended to be limiting of the present inventions. Thus, for example, as used herein, the singular forms “a”, “an” and “the” are intended to include the plural forms as well, unless the context clearly indicates otherwise. Moreover, the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

(Configuration of Information Processing System)

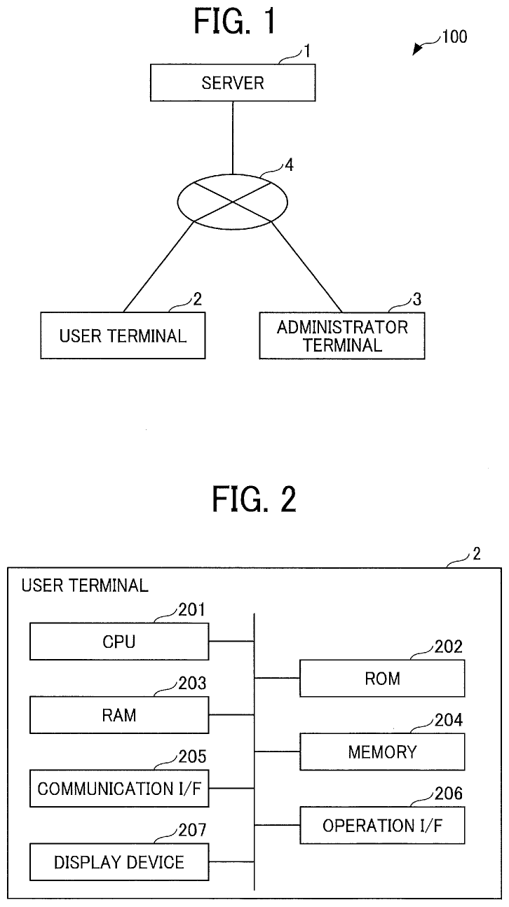

FIG. 1 is an example of configuration of an information processing system according to an embodiment of this disclosure. For example, a chat bot system 100, which is an example of the information processing system, employs a system configuration including, for example, a server 1, and a user terminal 2 used as information processing apparatuses. Further, as illustrated in FIG. 1, the chat bot system 100 may further include an apparatus other than the server 1 and the user terminal 2, such as an administrator terminal 3.

The server 1 is an example of information processing apparatus that can provide a chat bot service.

The user terminal 2 is an information processing apparatus that performs operations, such as inputting a question spoken by a user for the chat bot service. Further, the number of the user terminals 2 connected in the chat bot system 100 can be two or more. Further, the user terminal 2 may not be required to be connected in the chat bot system 100 constantly.

The administrator terminal 3 is an information processing apparatus, with which an administrator or the like performs given operations, such as an input operation, to manage or control the server 1.

The server 1, the user terminal 2, and the administrator terminal 3 are connectable with each other via, for example, communication network 4.

For example, the communication network 4 employs the Internet. Further, the communication network 4 may use a network of local area network (LAN), wide-area network (WAN), short-range communication using wired or wireless communication, or a combination thereof.

The server 1 communicates with the user terminal 2, and the administrator terminal 3. For example, the server 1 provides a chat bot service, in which when a user inputs a question sentence or statement, the server 1 returns a response, such as response message (answer message).

Further, the server 1 also provides services, such as transmitting and receiving messages among a plurality of users (i.e. chatting). That is, the server 1 provides instant messaging service. Further, various services may be provided using a plurality of information processing apparatuses. Hereinafter, with reference to FIG. 1, a description is given of an example case that the server 1, configured as one information processing apparatus, provides the service.

As to the chat bot service, when a user inputs a question statement to the user terminal 2, the server 1 acquires or obtains the question statement from the user terminal 2 via the communication network 4. Then, the server 1 searches information (hereinafter, referred to as “answer information” or “response information”) that becomes an answer to a question indicated by the question statement. Then, the server 1 generates a response message (answer message) based on the answer information to the question statement, and responds the response message (answer message) to the user terminal 2 via the communication network 4. Then, the user terminal 2 displays the answer information to the question statement using a format of the response message (answer message). Then, the user using the chat bot service can obtain the answer to the question by checking or confirming the displayed response message. In this description, the terms of “answer” and “response” are used interchangeably.

Specifically, each apparatus and database used for implementing the chat bot service employs, for example, a hardware configuration and data configuration to be described below.

(User Terminal)

FIG. 2 is an example of configuration of hardware block diagram of the user terminal 2. For example, the user terminal 2 includes central processing unit (CPU) 201, read only memory (ROM) 202, random access memory (RAM) 203, memory 204, communication interface (I/F) 205, operation interface (I/F) 206, and display device 207 as hardware resources. Further, the hardware resources of the user terminal 2 are connected to each other using, for example, bus or the like. Further, the hardware resources of the user terminal 2 may be connected to other device by wire or wireless communication.

The user terminal 2 is an information processing apparatus, such as personal computer (PC), smart phone, or tablet.

The CPU 201 implements functions, such as computing unit and control unit. Further, the CPU 201 is an example of a control device and computing device.

The ROM 202 is a storage device such as nonvolatile semiconductor.

The RAM 203 is a storage device such as volatile semiconductor.

The memory 204 is an example of a main storage device. For example, the memory 204 stores information acquired via the communication network 4. Further, the user terminal 2 may include an auxiliary storage device, such as hard disk or solid state drive (SSD). Further, the ROM 202, the RAM 203, and the memory 204 implement a function of storage unit.

The communication I/F 205 implements a function, such as communication unit. For example, the communication I/F 205 may be connection terminal and communication circuit.

The operation I/F 206 implements a function, such as input unit. For example, the operation I/F 206 is an input device, such as button, keyboard, dial, key, touch panel, microphone, or the like.

The display device 207 implements a function, such as output unit. For example, the display device 207 is an output device, such as liquid crystal panel, organic electroluminescence (OEL), or inorganic EL. Further the display device 207 and the operation I/F 206 may be integrated as a touch panel.

Further, the program may be stored in, for example, the auxiliary storage device, in addition to or instead of the ROM 202 and the memory 204. Further, the program may be acquired via the network.

(Administrator Terminal)

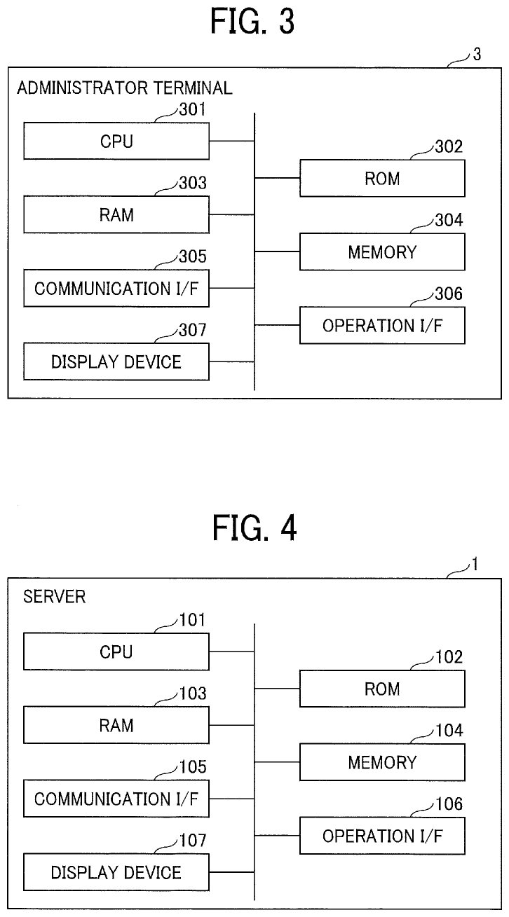

FIG. 3 is an example of configuration of hardware block diagram of the administrator terminal 3. For example, the administrator terminal 3 includes CPU 301, ROM 302, RAM 303, memory 304, communication I/F 305, operation I/F 306, and display device 307 as hardware resources. In this description, since the administrator terminal 3 employs the same hardware configuration as that of the user terminal 2, the description thereof is omitted. However, the administrator terminal 3 may employ a hardware configuration different from that of the user terminal 2 and the server 1.

(Server)

FIG. 4 is an example of configuration of hardware block diagram of the server 1. For example, the server 1 includes CPU 101, ROM 102, RAM 103, memory 104, communication I/F 105, operation I/F 106, and display device 107 as hardware resources. In this description, since the server 1 employs the same hardware configuration as that of the user terminal 2, the description thereof is omitted. However, the server 1 may employ a hardware configuration different from that of the user terminal 2 and the administrator terminal 3.

(Database)

When the chat bot service is performed in the chat bot system 100, the server 1 configures, for example, following databases (DBs) in advance. Hereinafter, a description is given of a case that the server 1 configures keyword DB, thesaurus DB, dialogue scenario DB, category DB, question-answer DB, inquiry history DB, dialogue history DB, and contract information DB.

The keyword DB stores text or character string indicating characteristics or feature of question and answer, that is used as keyword. The keyword may be word, phrase, or sentence. Further, the keyword DB may store keywords related to things other than question-answer information.

For example, at first, the server 1 decomposes a text string constituting an input question into each word. Then, the server 1 compares each word with words stored in the keyword DB to search a keyword related to the input question. Then, the server 1 searches a word, which matches the keyword, from the text string of “question” in the question-answer DB, and searches question-answer information to the input question. With this configuration, the keyword DB is used to extract the keyword indicated by the input question.

The thesaurus DB stores thesaurus information or synonym information on keyword. For example, the thesaurus information is information that associates text strings indicating similar meaning with each other. Further, the text string may be word, phrase, and sentence.

Further, the text strings whose meanings are similar to each other are not limited to the text strings having the similar meaning. For example, the text strings whose meaning are similar to each another include a text string that can be estimated from another text string, a text string that is a part of another text string, or a text string that is used in similar situation. Further, the thesaurus information may be arbitrarily defined according to the use situation.

At first, the server 1 decomposes one text string constituting a question statement, which is the input information, into each word. Then, the server 1 compares each word with the thesaurus DB to extract a text string that becomes a thesaurus. Then, the server 1 refers the word included in the question statement and the thesaurus of the word to the keyword DB to estimate a keyword related to the question statement.

The dialogue scenario DB stores scenario information that provides each dialogue corresponding to the input information including a question statement. For example, the scenario information is created so that a dialogue is performed with a user in accordance with a scenario input into the dialogue scenario DB in advance.

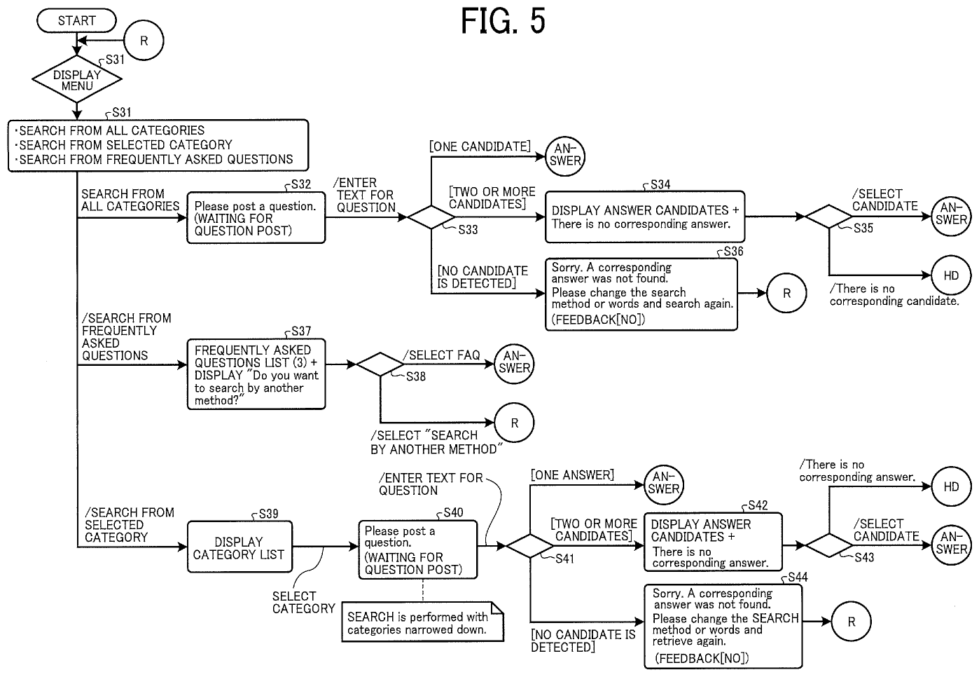

FIG. 5 is an example of flow of dialogue based on scenario information. For example, when a user inputs or enters a question statement, a flow of responding a response message or answer message, which is an answer to the question statement, can be performed based on the scenario information as indicated in FIG. 5.

(Flow of Dialogue Based on Scenario Information)

For example, the chat bot system 100 is input with scenario information by an administrator in advance to provide a flow illustrated in FIG. 5. Then, the chat bot system 100 performs a dialogue with a user based on the scenario information. Specifically, the chat bot system 100 is set with various information, such as scenario information, database, and graphical user interface (GUI) or the like in advance to enable communication indicated in the flow illustrated in FIG. 5. Hereinafter, with reference to FIG. 5, a description is given of the flow in detail.

In step S31, at first, the chat bot system 100 causes the user terminal 2 to display a selection menu, which displays a method of setting a question used for searching. For example, the selection menu is a GUI that receives a selection operation performed by a user, such as selecting from three options, such as “search from all categories,” “search from selected category,” and “search from frequently asked questions (FAQ).” Further, the selection menu may display four or more options or two or less options.

If a user selects “search from all categories” (“search from all categories” in FIG. 5) on the selection menu in step S31, the chat bot system 100 proceeds the sequence to step S32.

Further, if the user selects “search from frequently asked questions (FAQ)” (“search from frequently asked questions (FAQ)” in FIG. 5) on the selection menu in step S31, the chat bot system 100 proceeds the sequence to step S37.

Further, if the user selects “search from selected category” (“search from selected category” in FIG. 5) on the selection menu in step S31, the chat bot system 100 proceeds the sequence to step S39.

In step S32, the chat bot system 100 causes the user terminal 2 to display a message prompting the user to input or enter a question using text or character. Further, the chat bot system 100 causes the user terminal 2 to display a GUI, such as text box, on the user terminal 2, and receives an operation inputting text or character that becomes the question. When the user inputs the question (“enter text for question” in FIG. 5), the chat bot system 100 proceeds the sequence to step S33.

In step S33, the chat bot system 100 analyzes the text string indicating the question. Then, the chat bot system 100 searches the question-answer DB to extract a candidate that can become an answer to the question (hereinafter, simply referred to as “candidate”). Further, the chat bot system 100 may acquire a plurality of candidates as a result of the searching the question-answer DB.

If the number of candidates is one candidate as a result of the searching in step S33 (“one candidate” in FIG. 5), the chat bot system 1s00 uses the searched candidate as answer information.

Further, if the number of candidates is two or more candidates as a result of the searching in step S33 (“two or more candidates” in FIG. 5), the chat bot system 100 proceeds the sequence to step S34.

Further, if the number of detected candidates is zero as a result of the searching in step S33 (“no candidate is detected” in FIG. 5), the chat bot system 100 proceeds the sequence to step S36.

In step S34, the chat bot system 100 causes the user terminal 2 to display a GUI to be used by the user to perform an operation of selecting any candidate from a plurality of candidates, or an operation of not selecting any candidate from the plurality of candidates.

In step S35, if the operation of selecting any candidate from the plurality of candidates is performed (“select candidate” in FIG. 5), the chat bot system 100 sets the selected candidate as the answer information.

On the other hand, in step S35, if the operation of not selecting any candidate from the plurality of candidates is performed (“no corresponding candidate” in FIG. 5), the chat bot system 100 causes the user terminal 2 to display, for example, a sorry message indicating that an answer to the question cannot be displayed at this stage.

In step S36, the chat bot system 100 causes the user terminal 2 to display the sorry message and a message prompting the user to perform a re-searching, and then returns the sequence to step S31.

In step S37, the chat bot system 100 refers to the inquiry history DB to extract one or more questions (e.g., three or more) having higher frequency of inquiring from other users. Then, the chat bot system 100 causes the user terminal 2 to display a list of questions. Further, the chat bot system 100 causes the user terminal 2 to display a GUI, with which other search method can be selected.

In step S38, if a question is selected (“select FAQ” in FIG. 5), the chat bot system 100 sets an answer to the selected question, using a result obtained by searching the question-answer DB, as answer information or response information.

On the other hand, in step S38, if another search method is selected (“select search by another method” in FIG. 5), the chat bot system 100 returns the sequence to step S31.

In step S39, the chat bot system 100 causes the user terminal 2 to display a list of category name. Then, if a category is selected from the list of category name (“select category” in FIG. 5), the chat bot system 100 proceeds the sequence to step S40.

In step S40, the chat bot system 100 receives an operation of inputting text that becomes a question. Then, if the question is input or entered (“enter text for question” in FIG. 5), the chat bot system 100 acquires or obtains the question. Then, the chat bot system 100 proceeds the sequence to step S41.

In step S41, the chat bot system 100 searches the question-answer DB to extract a candidate.

If the number of candidates is one candidate (“one candidate” in FIG. 5) in step S41, the chat bot system 100 uses the searched candidate as answer information.

Further, if the number of candidates is two or more candidates (“two or more candidates” in FIG. 5) in step S41, the chat bot system 100 proceeds the sequence to step S42.

Further, if the number of detected candidates is zero (“no candidate is detected” in FIG. 5) in step S41, the chat bot system 100 proceeds the sequence to step S44.

In step S42, the chat bot system 100 causes the user terminal 2 to display a GUI to be used by the user to perform an operation of selecting any candidate from a plurality of candidates, or an operation of not selecting any candidate from the plurality of candidates.

In step S43, if the operation of selecting any candidate from the plurality of candidates is performed (“select candidate” in FIG. 5) in step S42, the chat bot system 100 sets the selected candidate as the answer information.

On the other hand, in step S43, if the operation of not selecting any candidate from the plurality of candidates is performed (“no corresponding candidate” in FIG. 5) in step S42, the chat bot system 100 causes the user terminal 2 to display, for example, a sorry message indicating that an answer to the question cannot be displayed at this stage.

In step S44, the chat bot system 100 causes the user terminal 2 to display the sorry message and a message prompting the user to perform a re-searching, and then returns the sequence to step S31.

As above described, the user, such as administrator, can input scenario information, for example, by assuming the above described flow of dialogue. That is, the scenario information indicates types of GUI used in the dialogue flow, sequential order of outputting message and GUI, which are set by the administrator.

The category DB stores category information for classifying questions. For example, the category information includes following information.

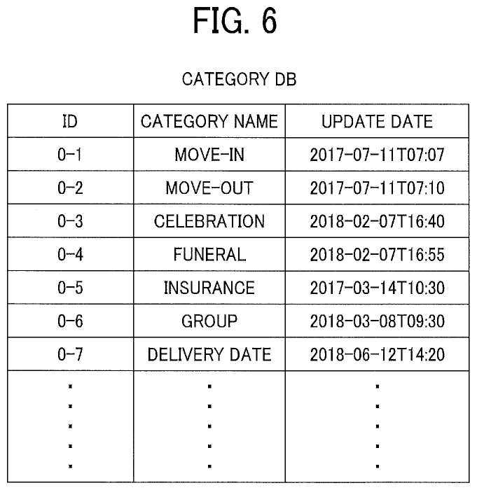

FIG. 6 is an example of the category information. For example, as illustrated in FIG. 6, the category information includes various information, such as “identification (ID),” “category name,” and “update date.”

“Category name” indicates a category to which each question is corresponded.

“ID” indicates identification, that is, identification of each category.

“Update date” indicates date and time when each information was updated.

The question-answer DB stores information associating questions and answers to the questions (hereinafter, referred to as “question-answer information”). For example, the question-answer information is created by an administrator or the like in advance, and then stored in the question-answer DB. For example, the question-answer information includes following information.

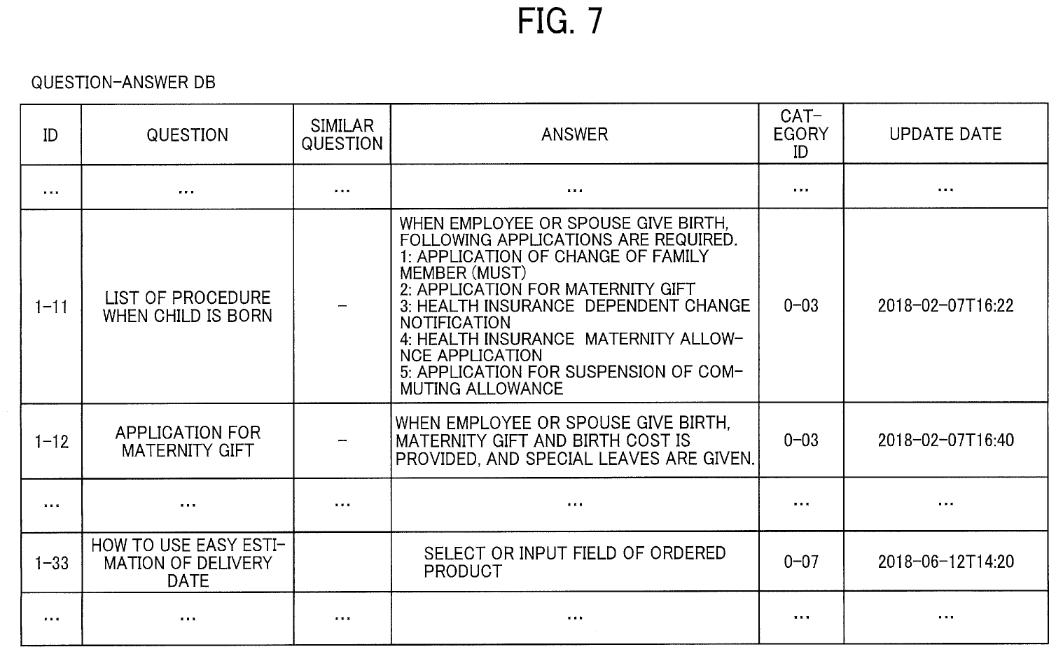

FIG. 7 is an example of question-answer information. For example, as illustrated in FIG. 7, the question-answer information includes various information, such as “ID,” “question,” “similar question,” “answer,” “category ID,” and “update date.”

“ID” indicates ID, that is, identification information of each question-answer information.

“Question” indicates content of question.

“Similar question” indicates a question that has content similar to the question entered in “question.”

“Answer” indicates an answer to each question.

“Category ID” indicates ID of category that can identify a category corresponding to the input question.

“Update date” indicates date and time when each information was updated.

The inquiry history DB stores information indicating the question input by the user (hereinafter, referred to as “inquiry history information”). For example, the inquiry history information includes following information.

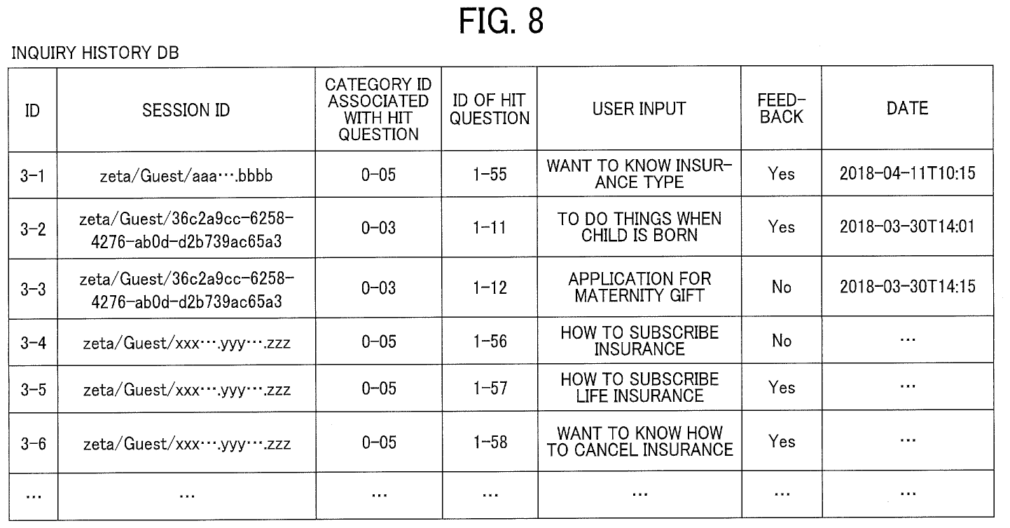

FIG. 8 is an example of inquiry history information. As illustrated in FIG. 8, the inquiry history information includes various information, such as “ID,” “session ID,” “ID of category associated with hit question,” “ID of hit question,” “user input,” “feedback,” and “date.”

“ID” indicates ID, that is, identification information of each inquiry history information.

“Session ID” indicates identification information identifying a dialogue session that was performed based on an input question.

“ID of category associated with hit question” indicates ID of category that can identify a category corresponding to the input question.

“ID of hit question” indicates ID of the input question.

“User input” indicates a question entered or input by a user.

“Feedback” indicates whether the user has made a feedback to an answer responding to a question.

“Date” indicates date and time when a dialogue was performed.

A dialogue session is a set of dialogues performed between the user terminal and the server. For example, a dialogue that becomes the same dialogue session is a dialogue performed at the user terminal 2 from a time of starting a screen used for dialogue, such as chat style, to a time of closing the screen, or a dialogue performed at the user terminal 2 from a time of starting a screen used for dialogue to a time of closing the screen forcibly due to the session time-out.

Further, the session time-out occurs when no action is performed to the user terminal 2 for a given period of time. The session time-out is processing of terminating the screen used for dialogue.

Further, the dialogue session is not limited to the above described example. For example, one dialogue session can be a period of inputting a question, answering a question to the input question, and then inputting a feedback by a user. In this case, when the feedback is acquired or obtained from the user, the one dialogue sessions is completed.

The dialogue history DB stores information indicating a history of spoken content input at the user terminal 2 and content output from the server 1 for a dialogue performed between the user terminal 2 and the server 1 (hereinafter, referred to as “dialogue history information”). For example, the dialogue history information includes following information.

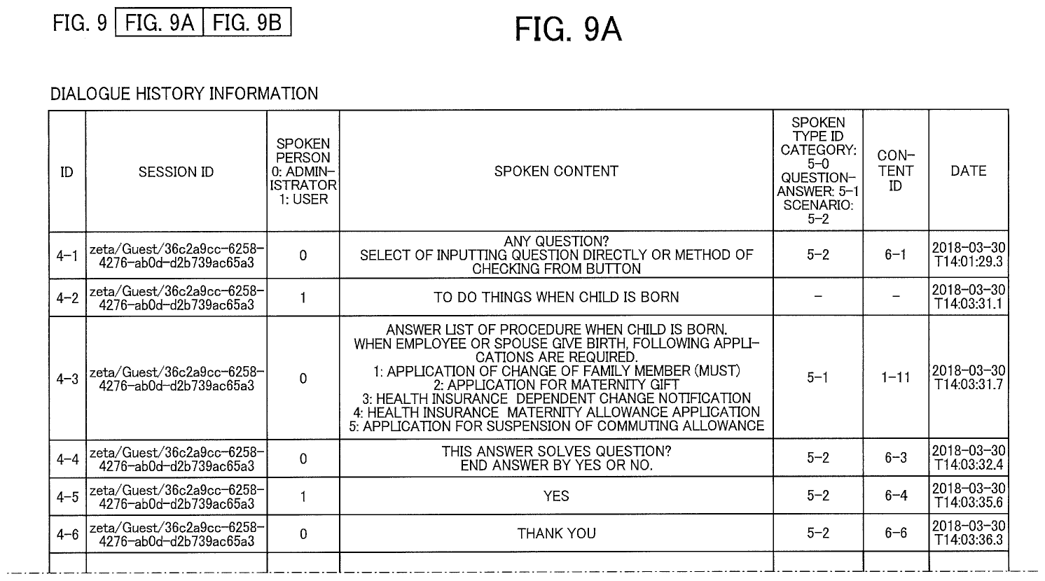

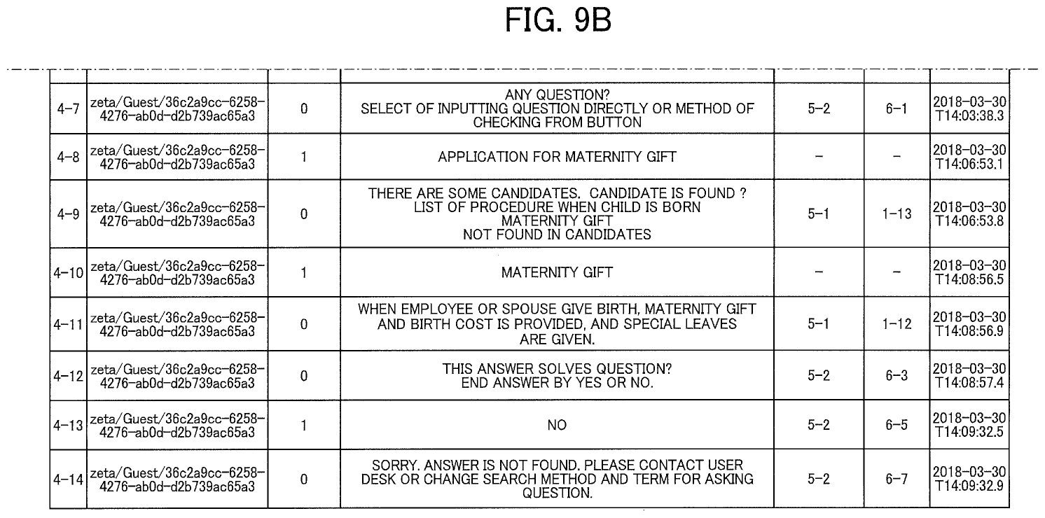

FIGS. 9A and 9B are an example of the dialogue history information. As illustrated in FIGS. 9A and 9B, the dialogue history information includes various information, such as “ID,” “session ID,” “spoken person,” “spoken content,” “spoken type ID,” “content ID,” and “date.”

“ID” indicates ID, that is, identification information of each dialogue history information.

“Session ID” indicates an ID that identifies a dialogue session when a dialogue was performed.

“Spoken person” indicates a type of speaker. Specifically, “spoken person” is input with values of “0” or “1.” “0” indicates that the speaker is an administrator. “1” indicates that the speaker is a user.

“Spoken content” indicates the content spoken by a speaker.

“Spoken type ID” is input, for example, as “5-0,” “5-1,” and “5-2.” Based on these inputs, “spoken type ID” indicates whether “spoken content” is spoken for any one of “category,” “question-answer information” and “scenario.”

“Content ID” indicates a spoken content set in the scenario if the spoken type is a scenario. Further, “content ID” indicates ID of question-answer information if the spoken type is question-answer information. Further, the “content ID” indicates a selection of category if the spoken type is a category.

“Date” indicates date and time when a dialogue was performed.

The contract information DB stores content of contract that is subscribed with a user in advance. For example, the contract is input with information, such as whether or not to perform an in-person response, and a time period of performing a response in advance. Further, the server 1 may retain information, such as the acquired contract information, in association with the tenant ID or the like.

Further, the type and configuration of DB are not limited to the above examples. That is, the DB may use any other format. Further, the DB can be configured to dispersed in a plurality of devices to retain data. Further, each DB may not be required. That is, if data that can implement the scenario is provided, the format of DB is not limited to any specific format.

(Functional Configuration)

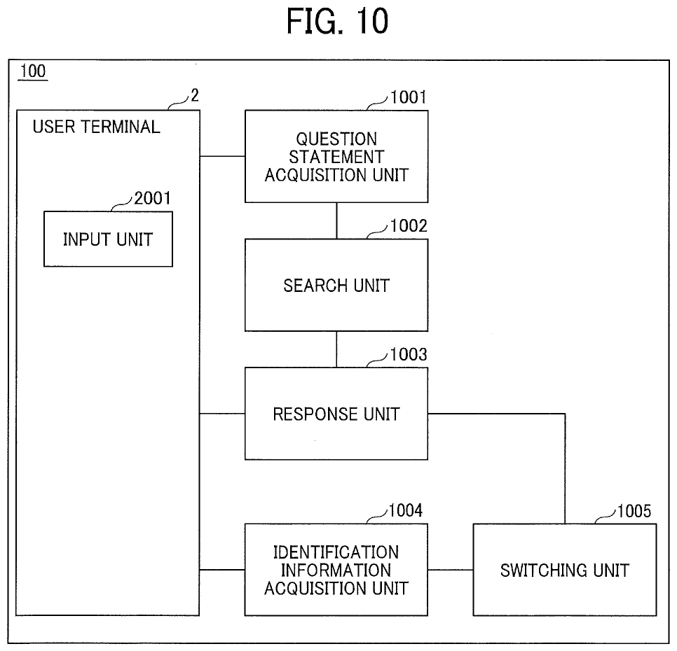

FIG. 10 is an example of configuration of functional block diagram of the chat bot system 100. For example, the chat bot system 100 includes question statement acquisition unit 1001, search unit 1002, response unit 1003, identification information acquisition unit 1004, and switching unit 1005 as functional units. Further, the user terminal 2 includes a functional unit, such as input unit 2001.

The input unit 2001 inputs a question statement using, for example, a browser, or an installed dialogue application.

The question statement acquisition unit 1001, the search unit 1002, and the response unit 1003 are used to search the answer information to the question statement, and to respond a response message (answer message) based on the answer information, with which a dialogue, such as bot, is implemented.

For example, the question statement acquisition unit 1001 performs a procedure for acquiring or obtaining a question statement from the user terminal 2, using the communication I/F 105 or the like.

Further, the search unit 1002 performs a procedure for searching answer information to the question statement using the CPU 101 or the like.

Further, the response unit 1003 performs procedure for responding a response message (answer message) to the user terminal 2 based on the answer information using the communication I/F 105 or the like.

The identification information acquisition unit 1004 performs a procedure for acquiring or obtaining user terminal identification information, such as internet protocol (IP) address, or user identification information (the identification information acquisition unit 1004 performs identification information acquisition procedure). For example, the identification information acquisition unit 1004 is implemented by the communication I/F 105 or the like.

The user terminal identification information is, for example, IP address. Further, the user terminal identification information can be any information that can identify the user terminal 2. For example, the user terminal identification information can be an identification number.

The user identification information is, for example, user ID that is set for each user in advance. Further, the user identification information can be any information that can identify a user. For example, the user identification information can be a user name.

The switching unit 1005 performs a procedure for switching response messages (answer messages) based on the user terminal identification information or the user identification information acquired by the identification information acquisition unit 1004. For example, the switching unit 1005 is implemented by the communication I/F 105 or the like.

The server 1 may further include functional units, such as computing unit and control unit, which may be implemented by the CPU 101 or the like. In addition, the server 1 may further include functional units, such as input unit, output unit, storage unit, and communication unit. Further, the user terminal 2 may include functional units, such as computing unit, control unit, storage unit, input unit, output unit, and communication unit.

(Processing)

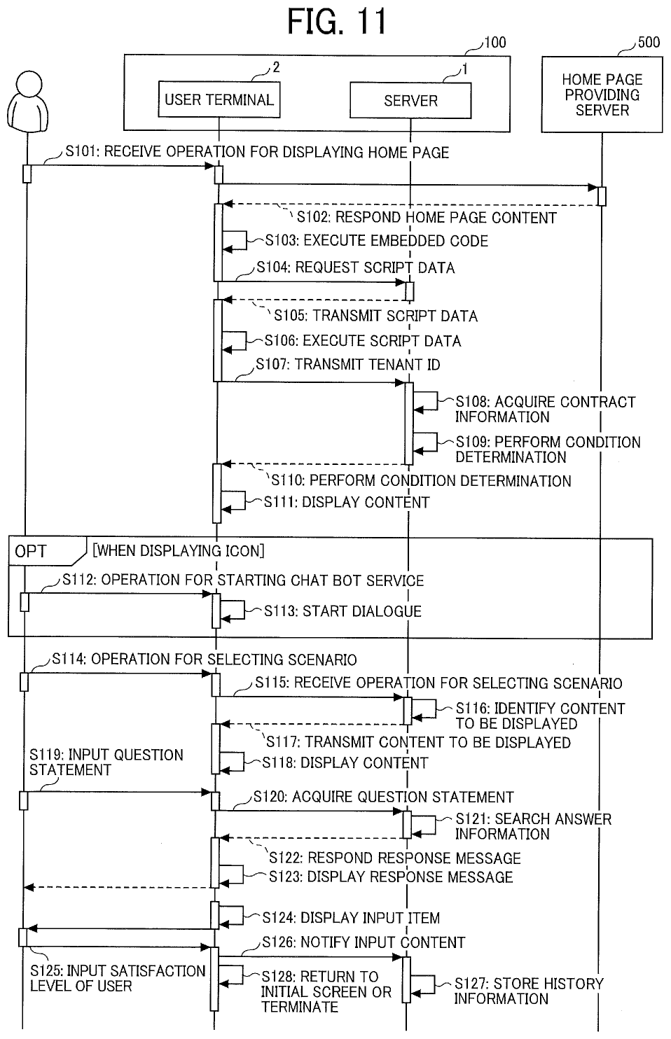

FIG. 11 is an example of sequence diagram of processing for implementing a chat bot service. Hereinafter, with reference to FIG. 11, a description is given of an example case that the server 1 alone performs processing for implementing the chat bot service. In this case, the user terminal 2 is an example of apparatus or device used by a user to input a question, and the user terminal 2 is also referred to as a question input source because the user terminal 2 used by the user becomes a source apparatus or device of inputting a question.

In step S101, the input unit 2001 receives an operation for displaying a home page. For example, the input unit 2001 receives an operation of inputting a universal resource locator (URL) of the home page to be displayed.

In step S102, a home page providing server 500 responds the content of requested home page to the user terminal 2. A code is embedded in advance in the source code of the home page as an embed code of the home page. By performing step S102, the user terminal 2 can be used to perform or execute the processing based on the embed code of the home page.

In step S103, the computing unit of the user terminal 2 executes the embed code of the home page.

In step S104, the communication unit of the user terminal 2 requests script data created by JavaScript (registered trademark) or the like based on the embed code of the home page.

In step S105, the communication unit of the server 1 transmits the script data requested in step S104 to the user terminal 2.

In step S106, the computing unit of the user terminal 2 executes the script data.

In step S107, the communication unit of the user terminal 2 transmits a chat bot content request, and a tenant ID identifying a chat bot subscriber (tenant) to the server 1. Further, when the user is to use a dialogue application installed on the user terminal 2, in response to receiving an operation of activating the dialogue application or an operation of pressing a given button of the dialogue application, the communication unit of the user terminal 2 transmits the chat bot content request, and the tenant ID identifying the chat bot subscriber (tenant) to the server 1.

The tenant ID is information retained by the user terminal 2 in advance. Further, the tenant ID may be retained by a browser used for the chat bot, or an application that implements the chat function.

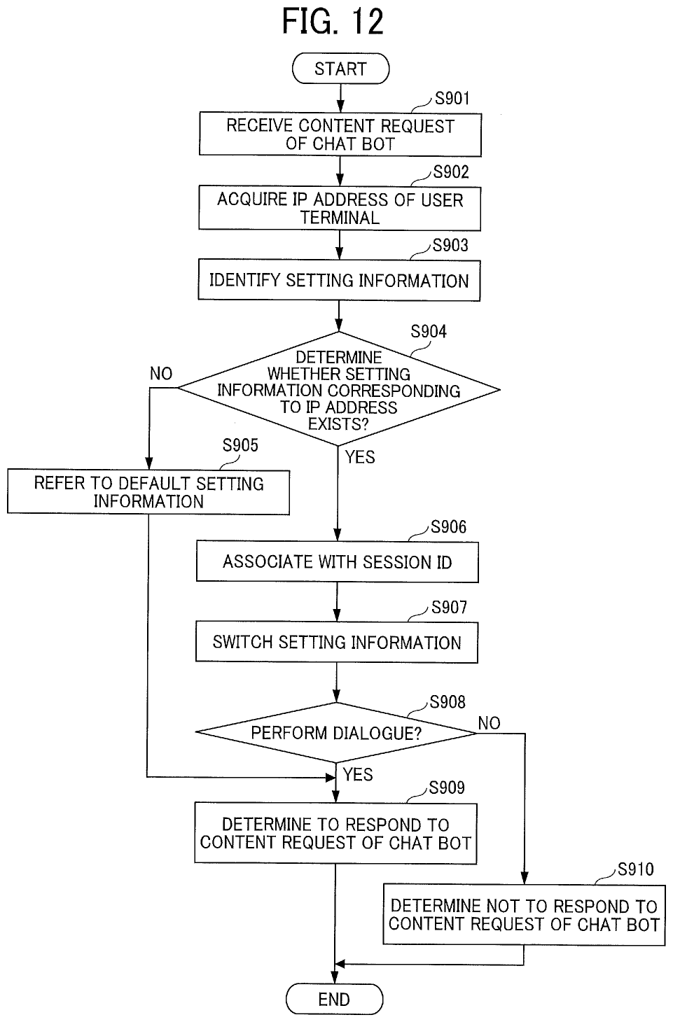

In step S108, the computing unit of the server 1 acquires contract information corresponding to the tenant ID from the contract information DB. Then, the computing unit of the server 1 determines the contract status based on the tenant ID. Hereinafter, with reference to FIG. 12, a description is given of an example case when it is determined that the contract is in a status that can use the chat bot service.

In step S109, the server 1 performs condition determination as follows as illustrated in FIG. 12.

FIG. 12 is an example of flowchart illustrating a processing of determining condition.

In step S901, the communication unit of the server 1 receives a content request of chat bot transmitted from the user terminal 2 in step S107.

In step S902, the IP address acquisition unit of the server 1 acquires the IP address of the user terminal 2. Further, the IP address may be acquired, for example, when the user terminal 2 accesses the server 1 at the first time, or may be acquired in step S107. That is, the timing of acquiring or obtaining the IP address is not limited to step S902, but may be acquired prior to step S902.

In step S903, the control unit of the server 1 identifies the setting information. For example, the setting information is set in advance as table data as indicated in the following Table 1. Hereinafter, a description is given of an example of registration of setting information.

TABLE 1
Tenant ID = 001

| | display/ | | | FAQ | thesaurus |
|---|---|---|---|---|---|
| | not | scenario | category | master | dictionary |
| IP address | display | ID | ID | ID | ID |
| 192.168.10.10/32 | display | 01, 02, 03 | | | |
| 192.168.11.1 to | not | — | — | — | — |
| 192.168.11.99 | display | | | | |
| 10.61.22.1/24 | display | 01, 02 | | | |
| Other than the | display | All | All | All | All |
| above | | | | | |

Table 1 is an example of table data preset for each “tenant ID.” Hereinafter, a description is given of an example case that one line of table data is one set of setting information.

At first, the control unit of the server 1 identifies the table data based on the “tenant ID” received in step S107.

The table data includes, for example, “IP address,” “display/not display,” “scenario ID,” “category ID,” “FAQ master ID,” and “thesaurus dictionary ID.”

“IP address” is the IP address of the user terminal 2. That is, if “display/not display” and “scenario” are to be set differently depending on the value of the IP address, the “IP address” is input with an IP address or a range of IP addresses, which becomes the target as described above.

“Display/not display” sets whether a displaying based on a scenario set by the “scenario ID” is performed or not (i.e., sets whether a dialogue is performed or not).

“Scenario ID” indicates the ID that identifies the scenario used for dialogue.

“Category ID,” “FAQ master ID,” and “thesaurus dictionary ID” indicate ID identifying a category used for scenario, ID identifying DB including FAQ master, and ID identifying DB including thesaurus dictionary.

Then, the control unit of the server 1 searches the settings corresponding to the IP address acquired in step S902. Specifically, for example, if the IP address is “192.168.11.2,” the server 1 determines that the IP address corresponds to “192.168.11.1 to 192.168.11.99.”

Therefore, by referring to the table data described above, the scenario used for dialogue can be set differently depending on the IP address. Further, if the IP address and scenario can be corresponded with each other, the setting information can use any format other than the table data described above.

In step S904, the determination unit of the server 1 determines whether or not the setting information corresponding to the IP address exists. For example, in an example case indicated in Table 1, if the IP address corresponds to “192.168.10.10/32,” “192.168.11.1” to “192.168.11.99,” or “10.61.22.1/24,” the determination unit of the server 1 determines that the corresponding setting information exists.

If the determination unit of the server 1 determines that the corresponding setting information exists (step S904: YES), the server 1 proceeds the sequence to step S906.

On the other hand, if the determination unit of the server 1 determines that the corresponding setting information does not exist (step S904: NO), the server 1 proceeds the sequence to step S905.

In step S905, the control unit of the server 1 refers to the default setting information.

The default setting information is, for example, the setting information input to “other than the above” in the example case indicated in Table 1. Further, the default setting information can be set as other data instead of the table data.

In step S906, the control unit of the server 1 associates with the session ID. For example, the control unit of the server 1 stores the ID that can identify the setting information in association with the session ID. If the ID that can identify the setting information is associated with the session ID, for example, if the same setting information is used for the same session (i.e., when the session of the same session ID is being performed), since the setting information is associated with the session ID, a time period required for identifying the setting information can be shortened.

In step S907, the switching unit 1005 of the server 1 switches the setting information. Specifically, in an example case of Table 1, the switching unit 1005 of the server 1 switches a scenario to perform a particular dialogue using a particular scenario corresponding to the IP address indicated by the table data.

In step S908, the control unit of the server 1 determines whether or not a particular dialogue is to be performed.

Then, if the control unit of the server 1 determines that the particular dialogue is to be performed (step S908: YES), the control unit of the server 1 proceeds the sequence to step S909.

On the other hand, if the control unit of the server 1 determines that the particular dialogue is not to be performed (step S908: NO), the control unit of the server 1 proceeds the sequence to step S910.

In step S909, the control unit of the server 1 determines that the server 1 responds to the content request of the chat bot. For example, if “display/not display” is “display” in Table 1, the control unit of the server 1 performs the settings for responding to the content request of the chat bot. Based on this determination, the settings are performed so that the particular dialogue using the scenario prepared in step S907 or the like is to be performed.

In step S910, the control unit of the server 1 determines that that the server 1 does not respond to the content request of the chat bot. For example, if “display/not display” is “not display” in Table 1, the control unit of the server 1 performs the settings not responding to the content request of the chat bot even if the server 1 receives the content request of the chat bot.

As described above, the answer information is switched based on the IP address of the user terminal 2. Therefore, since the scenario to be used can be set differently depending on the IP address of the user terminal 2, even if the same question sentence or statement is input, the server 1 can be configured to control to respond or output different response messages (answer messages).

For example, when the IP address is checked, the server 1 can determine whether the user terminal 2 is a terminal connected to the in-house network (an example of first inquiry or question input source) or the user terminal 2 is a terminal connected to an external network other than the in-house network (an example of second inquiry or question input source).

That is, as to the user terminal 2 connected to the in-house network, the user is employee or the like. On the other hand, as to the user terminal 2 connected to the external network, the user is so-called outsider.

Therefore, it is preferable to selectively use the information that is answered through the dialogue depending on whether the user determined by the IP address of the user terminal 2 is an employee or an outsider. The switching unit 1005 of the server 1 can implement the above described selective use of information by switching the setting information.

Step S109 are performed as described above.

Referring back to FIG. 11, in step S110, the communication unit of the server 1 transmits information, such as content information, to the user terminal 2 to perform the particular dialogue using the chat bot.

Further, if the control unit of the server 1 determines that that the server 1 does not respond to the content request of the chat bot in step S109 (i.e., when step S910 is performed), the content information is not transmitted, and the subsequent processing is aborted.

In step S111, the output unit of the user terminal 2 displays the content used for performing the particular dialogue using the chat bot.

Further, the administrator may set to display an icon used for an operation of starting the chat bot service in advance. In this case (“when displaying icon” in FIG. 11), the chat bot system 100 proceeds the sequence to step S112. On the other hand, if the setting is not displaying the icon, the chat bot system 100 proceeds the sequence to step S114.

In step S112, the user presses, for example, an icon for starting the chat bot service. Then, the input unit of the user terminal 2 receives the operation of pressing the icon.

In step S113, the output unit of the user terminal 2 starts the particular dialogue using the chat bot based on the scenario. Hereinafter, a description is given of an example case when a user selects the particular scenario and starts the particular dialogue.

In step S114, the user performs an operation for selecting the particular scenario. Specifically, as indicated in Table 1, a plurality of “scenario IDs” may be set. In this case, the output unit of the user terminal 2 displays a graphical user interface (GUI) so that the user can select any one of the plurality of scenarios using the GUI as the particular scenario.

In step S115, the input unit of the server 1 receives the operation for selecting the particular scenario performed in step S114. Then, the communication unit of the server 1 transmits a notification indicating the selected particular scenario to the control unit of the server 1.

In step S116, the control unit of the server 1 identifies content to be displayed for the particular dialogue based on the scenario identified by the setting information.

For example, if an option of “select from all categories” is selected in step S31 (FIG. 5), the content is identified so as to respond “category name” of a category set by “category ID” included in the setting information that is switched in step S109.

Further, if an option of “select from FAQ” is selected in step S31 (FIG. 5), for example, questions of the upper fifth level are extracted based on the inquiry history information generated within a pre-set time period.

Further, for example, a scenario of “checking extension telephone” may be selected in step S114. In this case, for example, the content is identified to respond a pre-set message, such as “please enter name.”

In step S117, the communication unit of the server 1 transmits the content to be displayed.

In step S118, the output unit of the user terminal 2 displays the content transmitted in step S117. Hereinafter, it is assumed that the question, search, and response are performed as illustrated in FIG. 5 based on the scenario determined in step S109.

In step S119, the user performs an operation to input a question statement. Then, in step S119, the input unit 2001 of the user terminal 2 receives the input of the question statement.

In step S120, the question statement acquisition unit 1001 acquires the question statement from the user terminal 2.

In step S121, the search unit 1002 searches answer information to the question statement.

In step S122, the response unit 1003 responds a response message (answer message) based on the answer information.

In step S123, the output unit of the user terminal 2 displays the response message (answer message).

The processing of step S119 to step S123 may be repeated, as needed. Further, after responding the answer, that is, after performing step S123, the processing of steps S124 to S128 may be performed.

In step S124, the output unit of the user terminal 2 displays an input item for investigating or checking a satisfaction level of user. That is, the output unit of the user terminal 2 displays a GUI of questionnaire to be used for investigating or checking the satisfaction level of user for the answer obtained in step S123, in which the GUI is used by the user to input the satisfaction level.

In step S125, the user inputs the satisfaction level using the GUI.

In step S126, the communication unit of the user terminal 2 notifies the content input in step S125, that is, a result of questionnaire, to the server 1.

In step S127, the storage unit of the server 1 stores history information of the content or dialogue content notified in step S126.

Further, the server 1 can perform statistical processing of satisfaction level based on the content of the satisfaction level. Specifically, the server 1 displays the satisfaction level of the dialogue that was performed using the chat bot within the given time period (e.g., satisfaction level of “satisfied,” “unsatisfactory,” “not applicable,” and “unknown” are input by a user in step S125) to an administrator using a graph or the like. Based on a feedback of the result of statistical processing of satisfaction level, the administrator can check or recognize the objective satisfaction level to the chat bot.

In step S128, the control unit of the user terminal 2 returns the sequence to, for example, step S112 or step S114. That is, the control unit of the user terminal 2 returns the sequence to the initial screen of the chat bot. Further, in step S128, the chat bot system 100 may terminate the chat bot.

As described above, when the answer information is switched based on the IP address, the response message (answer message) can be displayed differently for each IP address. For example, the information displayed for the user terminal 2 connected to the in-house network and the information displayed for the user terminal 2 connected to the external network can be set differently.

As described above, it is preferable to determine whether the user terminal 2 is connected to a given network or not based on the IP address. Further, the given network is, for example, a network managed by a company.

Further, the determination whether the user terminal 2 is connected to the given network or not may be performed using data other than IP address. For example, a physical address set for the user terminal 2 may be used as the data for determining whether the user terminal 2 is connected to the given network or not.

For example, information indicating contact information of other employees may be displayed on the user terminal 2, used by one employee, connected to an in-house network. On the other hand, the contact information of employees shall not be displayed on the user terminal 2 used by outsider. With this configuration, leaking of information, such as employee information, can be prevented.

Specifically, if the IP address of the user terminal 2 used as the question input source is determined to be the IP address of the user terminal 2 connected to the in-house network, a response message notifying the contact information or the like is responded to the user terminal 2. Further, the response message (answer message) responded to the user terminal 2 may be an inquiry of employee name or employee number identifying the employee.

Then, the server 1 responds, for example, a response message (answer message) indicating an extension telephone or room number to the question statement. With this configuration, the user can obtain or access the contact information of given employees by inputting an inquiry of contact information in the question statement.

On the other hand, if the user is an outsider, the server 1 responds a response message (answer message) of “this question cannot be answered,” or answer information or response information indicating a representative telephone number of company. With this configuration, the server 1 switches the answer information depending on the users. When the above described switching is performed, the response message (answer message) displayed on the user terminal 2 is switched.

Further, the switching of answer information may be implemented, for example, by switching the dialogue scenario DB based on the IP address. That is, the dialogue scenario DB for internal use and the dialogue scenario DB for external use may be prepared separately in advance, and the dialogue scenario DB may be switched based on the IP address. As above described, the switching of the answer information may be implemented by switching the DB to be searched by the search unit 1002.

Alternatively, for example, the switching of answer information may be implemented by switching the question-answer DB depending the IP address even if the same scenario is used. In this case, answers to questions for internal use and answers to questions for external use are set to the question-answer DB in advance. With this configuration, the switching of the answer information is implemented by switching the answer to the question.

With this configuration, the chat bot can respond differently to the internal use and external use without providing separate chat bots for the internal use and for external use. Therefore, one chat bot can be used for the internal use and for external use. With this configuration, the number of management target resources, such as the number of chat bots, can be reduced for operating the internal use and external use.

Further, if the number of management target resources is lesser, for example, the time duration and workload required to manage or maintain the information processing apparatuses and data for implementing the chatbot can be reduced.

Further, the information processing apparatus can flexibly or selectively respond different response messages (answer messages) to the users or the user terminals depending on the users or the user terminals, which is the question input source, for the same question statement.

Further, the “same question statement” does not necessarily mean that text strings of question statement input by a user are not necessarily completely the same. For example, when a use uses the input unit 2001 of the user terminal 2 to input two question statements, such as “Please tell me specifications of Product A,” and “I want know specifications of Product A,” the two question statements are not completely the same.

However, the question statement acquisition unit 1001 of the information processing apparatus analyzes the text strings of the acquired two question statements, and then interprets that both of the two question statements are requesting information on the specifications of “Product A.” Therefore, the question statement acquisition unit 1001 requests the search unit 1002 to search the information on the specifications of “Product A” for both of the two question statements. In this case, the two question statements become the “same question statement.”

Further, for example, if “Product A” and “another Product A” exist, “Please tell me specifications of Product A” and “I want know specifications of another Product A” become the “same question statement.”

Specifically, in the above described example, “please tell me” and “I want to know” are registered in the thesaurus dictionary in association with each other, and “Product A” and “Product A” are registered in the thesaurus dictionary in association with each other, and then the question statement acquisition unit 1001 can request the search unit 1002 to perform the searching based on the thesaurus dictionary.

That is, if the text strings of a plurality of question statements are analyzed, and then the interpretation of the plurality of question statements becomes the same based on the analysis result for each of the question statements and the thesaurus dictionary, the question statement acquisition unit 1001 processes or recognizes the plurality of question statements as the same question statement.

On the other hand, if the text strings of the plurality of question statements are analyzed, and then the interpretation of the plurality of question statements becomes different based on the analysis result for each of the question statements and the thesaurus dictionary, the question statement acquisition unit 1001 processes or recognizes the plurality of question statements as different question statements.

Further, if the text strings of the plurality of question statements are completely matched, the question statement acquisition unit 1001 processes or recognizes the plurality of question statements as the same question statement.

Further, how to interpret a question statement can be determined from a view point of user. That is, the question statement acquisition unit 1001 is implemented to interpret the question statement from the view point of user. With this configuration, in the above described example, since the two question statements of “Please tell me specifications of Product A” and “I want know specifications of Product A” can be interpreted as the same or identical from the view point of user, the question statement acquisition unit 1001 can interpret the two question statements as the same question statement.

(Determination Based on IP Address)

For example, it is preferable to determine whether the user terminal 2 is the “in-house network connection terminal” or the “external network connection terminal” based on the IP address as indicated in the following Table 2. Hereinafter, a description is given of an example case that the IP address is IPv4. In this example case, the IP address is composed of four numerical values, and each of which is separated by dot “.”

The server 1 compares an IP address set as a reference address for comparison in advance (hereinafter, referred to as “comparison-reference address”) and the IP address acquired from the user terminal 2 to determine any one of results indicated in the following Table 2.

TABLE 2

Same. Same. Same. Different
Same. Same. Different. —
Same. Different. —. —
Different. —. —. —

As to Table 2, one numerical value that constitutes the comparison-reference (hereinafter, referred to as “first numerical value”) and another numerical value that constitutes the IP address of the user terminal 2 (hereinafter, referred to as “second numerical value”) match with a higher degree (hereinafter, referred to as “matching level”) as upper the position in Table 2.

As to Table 2, when the first numerical value and the second numerical value are the same value based on the comparison result, “same” is set. On the other hand, when the first numerical value and the second numerical value are different based on the comparison result, “different” is set.

Therefore, the server 1 determines that the user terminal 2 is an “in-house network connection terminal” when the matching level is higher. Specifically, the server 1 determines that the user terminal 2 is the “in-house network connection terminal” in a case that the matching level of the uppermost level or the second level of Table 2 is detected. On the other hand, the server 1 determines that the user terminal 2 is the “external network connection terminal” in a case that the matching level of the lowest level or the third level of Table 2 is detected. As above described, the server 1 preferably determines the “in-house network connection terminal” or the “external network connection terminal” depending on the matching level of the IP address.

Further, as to Table 2, a threshold value determining which terminal becomes the “in-house network connection terminal” or “external network connection terminal” can be set, for example, based on a scale of the in-house network. Specifically, in a case that a network is a small-scale network connecting a few information processing apparatuses, the server 1 may be set such that only the upper-most level of Table 2 is determined as the “in-house network connection terminal.”

Further, the comparison-reference address may be, for example, an IP address set for the server 1. When the comparison-reference address set for the server 1 is used, IP addresses for the in-house network are set in the server 1.

Further, the above described example indicates that the IP address is IPv4, but the IP address can be IPv6.

Further, data such as a subnet mask may be used for the above described determination.

(Registration of Setting Information)

For example, the setting information is registered using GUI as described below.

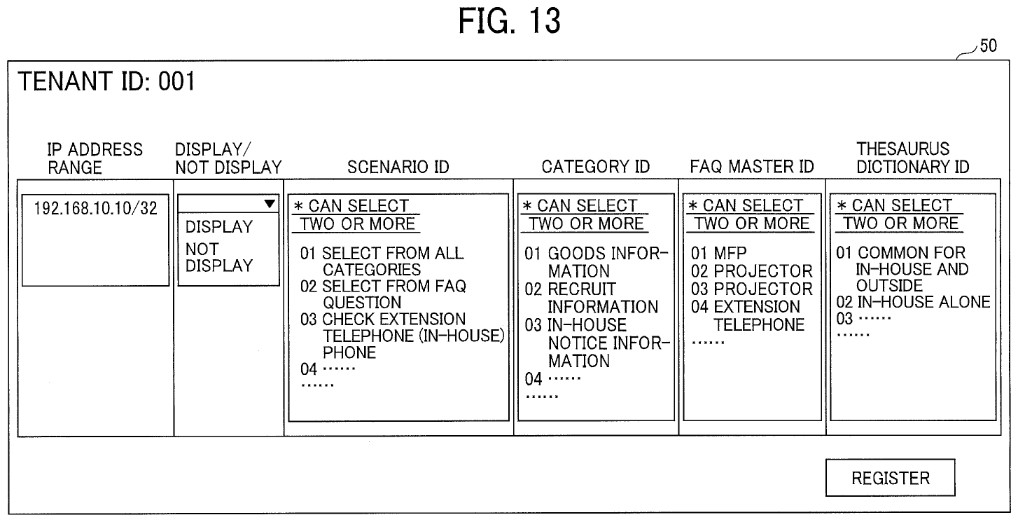

FIG. 13 is an example of registration of setting information. For example, a GUI, such as a registration screen 50, is used to register the setting information indicated in Table 1.

An administrator or the like sets items, such as “IP address range,” “display/not display,” “scenario ID,” “category ID,” “FAQ master ID”, and “thesaurus dictionary ID” on the registration screen 50 in advance. That is, each item to be input on the registration screen 50 is registered, for example, as indicated in Table 1. As illustrated in FIG. 13, each item may be selected by a pull-down menu or the like. Further, as illustrated in FIG. 13, the setting information may designate “tenant ID” or the like.

Further, the setting information may be registered in a manner other than the GUI illustrated in FIG. 13. For example, the setting information may be registered by inputting the contents similar to the contents illustrated in FIG. 13 into a file for spreadsheet software.

(When Using Dialogue Application)

The switching unit 1005 can be configured to control a response or answer to the user terminal 2 based on the user identification information. That is, the identification information acquisition unit 1004 can be configured to acquire the user identification information identifying the user.

For example, application software such as a dialogue application may be installed on the user terminal 2 in advance, and a chat bot may be performed by executing the dialogue application. In this case, a login operation is typically performed when to use the dialogue application. When the login operation is performed, the user ID and password are input to identify the user.

For example, the user ID is associated with a division or organization to which the user belongs, in advance. Therefore, when the user ID is obtained, the organization to which the user belongs can be identified.

Further, the scenario, category, FAQ master, and thesaurus are associated with the organization in advance. Further, information associating the question statement and answer information (hereinafter, referred to as “registration information”) is registered in advance. With this configuration, if the user ID is identified, the search unit 1002 can switch the registration information to be searched (i.e., search target) based on the user ID. When the registration information is switched, resultantly, the answer information to be searched is also switched, with which the to-be-responded or answered response message (answer message) becomes different depending on the user ID.

Further, the user identification information and the user terminal identification information may be used in combination. In this case, the search unit 1002 switches the registration information to be searched (i.e., search target) based on both of the user identification information and the user terminal identification information.

In conventional methods, the same response may be typically returned as a response in response to receiving question sentences input from different user terminals or in response to receiving question sentences or statement input by different users. Specifically, if one question sentence or statement is input from one user terminal connected to a given network and another question sentence or statement is input from another user terminal connected to other network, and the two question sentences are similar, the chat bot may answer a similar answer message to the one user terminal and another user terminal. Further, if one question sentence is input from one user belonging to one entity and another question sentence is input from another user not belonging to the one entity, and the two question sentences are similar, the chat bot may answer a similar answer message to the one user and another user. Therefore, the chat bot may output or respond answer messages not matching to types of question input source, which means the chat bot cannot output or respond answer message selectively or flexibly.

As to the above described embodiment, the chat bot can respond flexibly depending on the question input sources.

In the above described information processing system, each step of the information processing method may be performed by a plurality of information processing apparatuses in parallel, distributed or redundantly. Further, the information processing system can be configured to utilize so-called cloud computing or the like.

Further, each apparatus may not be one apparatus. That is, each apparatus may be a combination of a plurality of apparatuses. Further, the information processing system may further include one or more apparatuses other than the apparatus described above.

Further, the information processing system and the information processing apparatus may use an artificial intelligence (AI) or the like. For example, the information processing system and the information processing apparatus can be configured to perform the machine learning or the like for inputting text to improve the recognition precision.

Further, a part of an entire of the processing according to the above described embodiment may be implemented by one or more programs described in a computer language and executable by a computer for performing the information processing method. That is, the one or more programs is computer programs for performing the information processing method by the computer such as the information processing apparatus or information processing system.

Therefore, when the information processing method is performed by executing the program, the computing device and the control device of the computer perform operations and controls based on the program to perform the respective procedures. Further, a storage device of the computer stores data used for processing based on the program to perform each procedure.

Further, the program can also be recorded on a computer-readable storage medium and distributed. Further, the storage medium may be magnetic tape, flash memory, optical disk, magneto-optical disk, magnetic disk, or the like. Further, the program may be distributed through a communication line.

Numerous additional modifications and variations are possible in light of the above teachings. It is therefore to be understood that, within the scope of the appended claims, the disclosure of this specification can be practiced otherwise than as specifically described herein. Any one of the above-described operations may be performed in various other ways, for example, in an order different from the one described above.

Each function of the above-described embodiment can be implemented by one or more processing circuits. The “processing circuit” includes a processor which is programmed to perform each function by software such as a processor implemented by an electronic circuit, and device designed to perform each function described above, such as application specific integrated circuit (ASIC), digital signal processor (DSP), field programmable gate array (FPGA), conventional circuit module, or the like.

What is claimed is:

1. An information processing apparatus connectable with a user terminal via a network, the information processing apparatus comprising:
circuitry configured to
acquire a question statement input to the user terminal by a user;
search response information to be responded to the question statement;
respond, to the user terminal, a response message based on the searched response information to the question statement; and
control output of the response message to the question statement input to the user terminal such that a first response message responding to a first question input source used for inputting a first question statement, and a second response message responding to a second question input source used for inputting a second question statement are different even if the first question statement and the second question statement are similar or the same.

2. The information processing apparatus according to claim 1,
wherein the first question input source is a first user terminal that receives the first question statement, and the second question input source is a second user terminal that receives the second question statement, and
wherein the circuitry controls the output of the response message to the question statement input to the user terminal such that the first response message responding to the first question input source used for inputting the first question statement, and the second response message responding to the second question input source used for inputting the second question statement are different even if the first question statement and the second question statement are similar or the same.

3. The information processing apparatus according to claim 2,
wherein the circuitry acquires first user terminal identification information identifying the first user terminal and second user terminal identification information identifying the second user terminal, and
wherein the circuitry controls the output of the response message to the first user terminal and the second user terminal based on the acquired first user terminal identification information and the second user terminal identification information.

4. The information processing apparatus according to claim 3,
wherein the first and second user terminal identification information are respectively an internet protocol (IP) address of the first user terminal and an IP address of the second user terminal.

5. The information processing apparatus according to claim 4,
wherein the circuitry controls the output of the response message to the first user terminal and the second user terminal based on a matching level between a first numerical value constituting an IP address used as a comparison-reference address and a second numerical value constituting the IP address of the first user terminal or the IP address of the second user terminal compared with the comparison-reference address.

6. The information processing apparatus according to claim 4,
wherein the circuitry determines whether or not each of the first user terminal and the second user terminal is a terminal connected to a given network based on the IP address of the first user terminal and the IP address of the second user terminal.

7. The information processing apparatus according to claim 1,
wherein the circuitry further acquires user identification information identifying the user who has input the question statement from the user terminal, and
wherein the circuitry controls the output of the response message to the user terminal operated by the user based on the acquired user identification information.

8. The information processing apparatus according to claim 1,
wherein the circuitry searches registration information associating the question statement and the response information as a search target, and
wherein the circuitry switches the registration information to be searched.

9. The information processing apparatus according to claim 1,
wherein the circuitry controls the output of the response message to the user terminal operated by the user based on the user terminal that receives the input of the question statement, and the user who has input the question statement to the user terminal.

10. An information processing system comprising:
a user terminal used for receiving an input from a user, and
an information processing apparatus connectable with the user terminal via a network, the information processing apparatus including circuitry configured to:
acquire a question statement input to the user terminal by a user;
search response information to be responded to the question statement;
respond, to the user terminal, a response message based on the searched response information to the question statement; and
control output of the response message to the question statement input to the user terminal such that a first response message responding to a first question input source used for inputting a first question statement, and a second response message responding to a second question input source used for inputting a second question statement are different even if the first question statement and the second question statement are similar or the same.

11. The information processing system according to claim 10,
wherein the first question input source is a first user terminal that receives the first question statement, and the second question input source is a second user terminal that receives the second question statement, and
wherein the circuitry controls the output of the response message to the question statement input to the user terminal such that the first response message responding to the first question input source used for inputting the first question statement, and the second response message responding to the second question input source used for inputting the second question statement are different even if the first question statement and the second question statement are similar or the same.

12. The information processing system according to claim 11,
wherein the circuitry acquires first user terminal identification information identifying the first user terminal and second user terminal identification information identifying the second user terminal, and
wherein the circuitry controls the output of the response message to the first user terminal and the second user terminal based on the acquired first user terminal identification information and the second user terminal identification information.

13. The information processing system according to claim 12,
wherein the first and second user terminal identification information are respectively an internet protocol (IP) address of the first user terminal and an IP address of the second user terminal.

14. The information processing system according to claim 13,
wherein the circuitry controls the output of the response message to the first user terminal and the second user terminal based on a matching level between a first numerical value constituting an IP address used as a comparison-reference address and a second numerical value constituting the IP address of the first user terminal or the IP address of the second user terminal compared with the comparison-reference address.

15. A method of processing information using an information processing apparatus connectable with a user terminal via a network, the method comprising:
acquiring a question statement input to the user terminal by a user;
searching response information to be responded to the question statement;
responding, to the user terminal, a response message based on the searched response information to the question statement; and
in the responding, controlling output of the response message to the question statement input to the user terminal such that a first response message responding to a first question input source used for inputting a first question statement, and a second response message responding to a second question input source used for inputting a second question statement are different even if the first question statement and the second question statement are similar or the same.

16. The method according to claim 15,
wherein the first question input source is a first user terminal that receives the first question statement, and the second question input source is a second user terminal that receives the second question statement, and
wherein the controlling controls the output of the response message to the question statement input to the user terminal such that the first response message responding to the first question input source used for inputting the first question statement, and the second response message responding to the second question input source used for inputting the second question statement are different even if the first question statement and the second question statement are similar or the same.

17. The method according to claim 16, further comprising:
acquiring first user terminal identification information identifying the first user terminal and second user terminal identification information identifying the second user terminal,
wherein the controlling controls the output of the response message to the first user terminal and the second user terminal based on the acquired first user terminal identification information and the second user terminal identification information.

18. The method according to claim 17,
wherein the first and second user terminal identification information are respectively an internet protocol (IP) address of the first user terminal and an IP address of the second user terminal.

19. The method according to claim 18, further comprising:
wherein the controlling controls the output of the response message to the first user terminal and the second user terminal based on a matching level between a first numerical value constituting an IP address used as a comparison-reference address and a second numerical value constituting the IP address of the first user terminal or the IP address of the second user terminal compared with the comparison-reference address.
